(19) United States
(12) Patent Application Publication
(10) Pub. No.: US 2023/0177323 A1
(43) Pub. Date: Jun. 8, 2023

(54) IDENTIFYING DIFFERENCES IN COMPARATIVE EXAMPLES USING SIAMESE NEURAL NETWORKS

(71) Applicant: International Business Machines Corporation, Armonk, NY (US)

(72) Inventors: Thai F. Le, West Palm Beach, FL (US); Supriyo Chakraborty, White Plains, NY (US)

(21) Appl. No.: 17/545,358

(22) Filed: Dec. 8, 2021

(51) Int. Cl. G06N 3/08; G06F 16/28

(52) U.S. Cl. CPC G06N 3/08; G06F 16/285

(57) ABSTRACT

A first instance of data and a second instance of data can be received, which have been classified differently. The first instance can be input to a first neural network, the first neural network generating a first encoding associated with the first instance. The second instance can be input to a second neural network the second neural network generating a second encoding associated with the second instance. The first neural network and the second neural network form neural network architecture trained to learn similarities in given pair of input objects. Based on the first encoding and the second encoding, a difference can be identified in features of the first instance and the second instance, which contributed to the first instance and the second instance being classified differently.

### STATEMENT REGARDING FEDERALLY SPONSORED RESEARCH OR DEVELOPMENT

This invention was made with Government support under W911NF-16-3-0001 awarded by the U.S. Army. The Government has certain rights to this invention.

### BACKGROUND

The present application relates generally to computers and computer applications, and more particularly to machine learning and explainable machine learning.

Machine learning usually takes input and produces output such as predictions and/or classifications, for example, without an explanation of how that output was derived. Existing techniques that attempt to explain outcome predictions of neural networks may focus on one instance of prediction at a time, and may strive to identify relevant features in that instance that contribute toward and against the model's prediction outcome. Such techniques do not allow one to identify differences between two or more specific instances. While other techniques may generate small perturbations that cause an instance to be classified into a different class and map the perturbations into the relevant features, such techniques also may not effectively provide explanation of differences in neural network outcomes of different instances. For example, the perturbations may cause the model to classify an instance into a different class for other reasons, e.g., such as the model being not well-trained, and/or not having learned a given task adequately. As such, currently no satisfactory solution explains differences in machine learning prediction outcomes such as neural network outcomes between different specific instances.

### BRIEF SUMMARY

The summary of the disclosure is given to aid understanding of a computer system and method of identifying differences in comparative outcome examples in machine learning, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A method, in an aspect, can include receiving a first instance of data and a second instance of data, where the first instance and the second instance have been classified differently. The method can also include inputting the first instance to a first neural network, the first neural network generating a first encoding associated with the first instance. The method can also include inputting the second instance to a second neural network, the second neural network generating a second encoding associated with the second instance. The first neural network and the second neural network form neural network architecture trained to learn similarities in given pair of input objects. Based on the first encoding and the second encoding, the method can include identifying a difference in features of the first instance and the second instance, which contributed to the first instance and the second instance being classified differently.

In another aspect, the method can include receiving a first instance of data and a second instance of data, where the first instance and the second instance have been classified differently. The method can also include inputting the first instance to a first neural network, the first neural network generating a first encoding associated with the first instance. The method can also include inputting the second instance to a second neural network, the second neural network generating a second encoding associated with the second instance. The first neural network and the second neural network form neural network architecture trained to learn similarities in given pair of input objects. Based on the first encoding and the second encoding, the method can include identifying a difference in features of the first instance and the second instance, which contributed to the first instance and the second instance being classified differently. The method can also include, to identify the difference, computing gradients of distance differences between the first encoding features and the second encoding features with respect to the first instance of data.

In another aspect, the method can include receiving a first instance of data and a second instance of data, where the first instance and the second instance have been classified differently. The method can also include inputting the first instance to a first neural network, the first neural network generating a first encoding associated with the first instance. The method can also include inputting the second instance to a second neural network, the second neural network generating a second encoding associated with the second instance. The first neural network and the second neural network form neural network architecture trained to learn similarities in given pair of input objects. Based on the first encoding and the second encoding, the method can include identifying a difference in features of the first instance and the second instance, which contributed to the first instance and the second instance being classified differently. The method can also include, to identify the difference, computing gradients of distance differences between the first encoding features and the second encoding features with respect to the first instance of data. The method can also include performing a post processing to the gradient to reduce noise.

A system, in an aspect, can include a processor and a memory device coupled with the processor. The processor can be configured to receive a first instance of data and a second instance of data, where the first instance and the second instance have been classified differently. The processor can also be configured to input the first instance to a first neural network, the first neural network generating a first encoding associated with the first instance. The processor can also be configured to input the second instance to a second neural network the second neural network generating a second encoding associated with the second instance, where the first neural network and the second neural network form neural network architecture trained to learn similarities in given pair of input objects. The processor can also be configured to, based on the first encoding and the second encoding, identify a difference in features of the first instance and the second instance, which contributed to the first instance and the second instance being classified differently.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram which illustrates identifying differences in comparative examples in an embodiment.

FIG. 2 is a flow diagram illustrating a method of identifying differences in comparative examples using neural network architecture formed with at least two neural network models in an embodiment.

FIG. 3 is a diagram showing components of a system in one embodiment that can generate a comparative explanation toward why given input instances result in different prediction outcome in machine learning.

FIG. 4 illustrates a schematic of an example computer or processing system that may implement a system according to one embodiment.

FIG. 5 illustrates a cloud computing environment in one embodiment.

FIG. 6 illustrates a set of functional abstraction layers provided by cloud computing environment in one embodiment of the present disclosure.

### DETAILED DESCRIPTION

Systems and methods can be provided, which can explain differences in machine learning prediction outcomes of two or more specific instances. In one or more embodiments, systems and methods disclosed herein can address a problem of identifying what features in different specific instances resulted in different prediction outcomes. For instance, consider that: given an instance, x, a neural network (or another machine learning model) generates a prediction outcome, y; and given an instance, x′, the neural network generates a prediction outcome, y′. The systems and methods may identify which features in x and x′ contributed to the different prediction outcomes, y and y′. In an aspect, the system and/or method can address the problem of identifying or explaining which features in x and/or x′ resulted in different prediction outcomes produced by a neural network.

In an embodiment, a comparative explanation framework can be provided, which provides an explanation for a difference in model prediction for two specific (e.g., related) sample instances. In an embodiment, a comparative explanation for a sample is conditioned on the other specific instance provided. More specifically, let instance x be predicted as label y, and instance x′ predicted as label y′, the framework in an embodiment seeks to explain which features in x compared to x′ caused it to be classified differently from x′.

In an embodiment, a system and/or method may identify differences for an instance x_0, compared to an instance x_1, by computing the product of (1) the gradient of the loss with respect to x_1, and (2) x_1, and selecting the top features with the largest negative values (the computed gradient values). The number of gradient values correspond to the number of input features. For example, considering a sentence with 10 words, each word may be represented by a vector of dimension 128. There can then be 10×128=1280 gradient values. In an aspect, for each vector of size 128 representing a word, the average of those 128 gradient values can be taken, to obtain one gradient value per word.

In an embodiment, a system and/or method may also identify differences between an instance x_0 and a class C_1 as follows: (1) Given a dataset of labeled instances, the system and/or method may identify the instance x_i closest to x_0 but belonging to the class C_1. For example, the system and/or method may pass each of x_0 and x_i through the neural network, and extract the representation of each input at the logit layer. The system and/or method may then apply a distance metric (e.g., cosine metric) between those representations to compute the distance between x_0 and x_i. (2) The system and/or method may then provide x_0 and x_i as inputs to a trained Siamese neural network, and identify features of x_i that led to the prediction outcome. The system and/or method may use those features as the pertinent negatives. In an embodiment, more specifically, a processor may compute the gradient of the loss with respect to x_i to identify features of x_i that maximize the loss, to identify the features from x_i that contributed to the model to classify x_0 and x_i as belonging to different classes.

In an embodiment, a neural network can be trained as follows. A training dataset may include n (or a plurality of) instances, with each instance including a pair of objects and a label indicating the class. Examples of objects can include, but are not limited to, sentences, pictures, data attributes, and/or others. Using the training dataset, a processor may train a neural network to predict the label for each instance (i.e., pair of objects).

In an embodiment, to derive an explanation, the following can be performed. Consider that there are two objects x_0, and x_1, belonging to two different classes. The system may compute the product of (1) the gradient of the loss with respect to x_1, and (2) x_1, and return the features in ascending values.

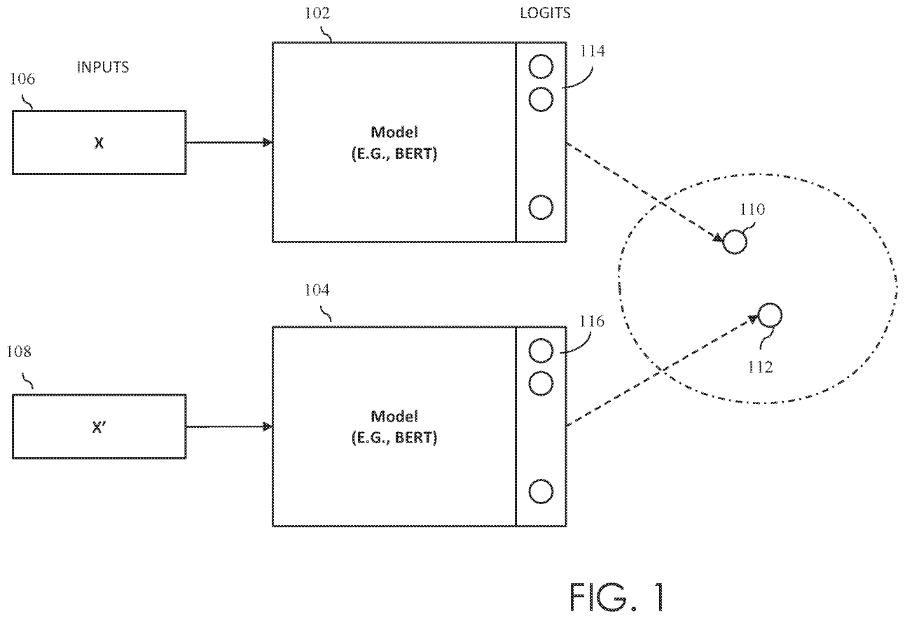

FIG. 1 is a diagram which illustrates identifying differences in comparative examples in an embodiment. Components of a system and/or method can be implemented or run on one or more computer processors, for example, including one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

A method and/or system in an embodiment takes at least two instances that are classified differently, and generates a comparative explanation towards why these instances result in different prediction outcome. In an embodiment, the explanation can include a ranked list of the features from each of the input instances that contributed towards or against the inputs being classified into the same class. In an embodiment, the comparative explanation provides differences between the two instances (e.g., inputs to a machine learning model), which resulted in different outcome.

For example, a processor may run two machine learning models, for example, neural networks 102, 104. Examples of the models can include, but are not limited to, Bidirectional Encoder Representations from Transformers (BERT), convolutional neural networks (CNNs), and/or others. In an embodiment, the two machine learning models 102, 104 can be considered a Siamese neural network, a class of neural network architecture that includes two or more identical networks, e.g., they have the same configuration with same hyperparameters and weights. In an embodiment, the models 102, 104 can be trained using a training dataset, which may include a plurality of instances, with each instance having an object and a label indicating the class. Examples of objects can include, but are not limited to, sentences, pictures, data attributes, and/or others. Using the training dataset, a processor may train models 102, 104 to predict the label for each instance (i.e., pair of objects).

The models 102, 104 may work in tandem on two different input or input vectors 106, 108. The models 102, 104 can compute comparable output vectors. In an embodiment, the systems and methods may identify differences between specific instances using the models 102, 104 (e.g., implemented as a Siamese neural network).

An input 106 (e.g., x, an anchor sentence) can be input to the model 102. The model 102 may produce output or classification 110. An input 108 (e.g., x′, a comparative sentence) can be input to the model 104. The model 104 may produce output or classification 112.

In an embodiment, the model (e.g., 102, 104), which can be a neural network, includes the final layer that uses a softmax function. For example, the final layer of the model (e.g., 102, 104) includes as the activation function the softmax function, e.g., which can normalize the output to a probability distribution. A logit (logistic regression) layer (e.g., 114, 116) before the final layer feeds into the softmax function. In an embodiment, the logit layer (e.g., 114, 116) is a vector of n dimensions, which can be projected.

In an embodiment, to understand or identify the comparative difference between two instances, a processor may find a loss, for example, some distance between one instance and another instance. For example, a processor may compute the derivative or gradient of that loss with respect to either x or x′. Loss can be the distance between the output of x and output of x′. There can be many type of loss or distance such as cross entropy. The processor may compute the gradient of the loss with respect to the input, e.g., x or x′. The gradient of the loss with respect to the input tells what feature in x or x′ will reduce the loss. For example, the loss is the measure of the distance, e.g., between 110 and 112. The computed gradient of the loss with respect to x or x′ can tell what to change in x or x′, so that the loss is reduced, for example, what in x or x′ should be changed for the distance between 110 and 112 to be closer. In an embodiment, the accuracy of the identified difference can be increased by multiplying the gradient of the loss with respect to the input with the input. Such a product (gradient of the loss with respect to the input multiplied by the input) can reduce a noise in the identified difference.

In an embodiment, the processor computes gradient of loss (e.g., logits(x), logits (x′)) with respect to x or x′. For example, logits(x) 114 and logits (x′) 116 are raw predictions output by the models, e.g., before being normalized by the final layer (e.g., softmax function layer). In an embodiment, by way of more specific example, the following computation can be performed.

loss = tf.nn.softmax_cross_entropy_with_logits(labels=predsl, logits=preds2)
gradient = tape.gradient(loss, word_embedding)
gradient_product = tf.math.abs(tf.math.multiply(gradient,word_embedding))

In the above computation, “loss” is computed using TensorFlow tf.nn.softmax_cross_entropy_with_logits, which computes softmax cross entropy between labels and logits. In this example, an outcome of one instance is set as labels and an outcome of another instance is set as logits.

In the above computation, “gradient” is computed using TensorFlow tape.gradient, which computes the gradient of loss with respect to an input instance This gradient can identify features in x or x′, which contributed to the difference in the different outcomes of the models.

In the above computation, “gradient_product” is computed by multiplying the gradient of loss with respect to an input instance with the input instance.

In an embodiment, one or more intermediate layers, l_i( ) can be taken, and the gradient of loss (l_i(x), l_i(x′)) with respect to x and x′ can be computed. Input features that contribute toward or against the loss can be identified. In an aspect, input features with a large negative gradient values reduce the loss.

Consider a use case example containing text (e.g., sentences) from a number of different newsgroups. A task for a machine learning model can be to predict the topic of each sentence. for example, a trained machine learning model such as a BERT model can be used. For example, a processor may feed the trained machine learning model the text sentences, and the trained machine learning model outputs its prediction. In some instances, there can be misclassification or misprediction, e.g., the model does not correctly predict the topic (e.g., as can be determined by comparing to the ground truth label). The system and/or method disclosed herein in one or more embodiments can explain why some sentences are misclassified.

An example existing method may work by identifying a keyword and removing that keyword from the text to determine whether the misclassification is due to the presence of that keyword. Another existing approach may work by replacing top words with synonyms. However, such methods can explain misclassification in only a few number of cases.

The system and/or method in an embodiment can take two instances (e.g., two sets of texts) that are classified differently, and generate an explanation as to why there are two different outcomes. The system and/or method in an embodiment may find a list of words or features of input that explain the difference, e.g., by computing a gradient of loss of the two outcomes. Features can be words or text, attributes of data, pixels for images, and/or others.

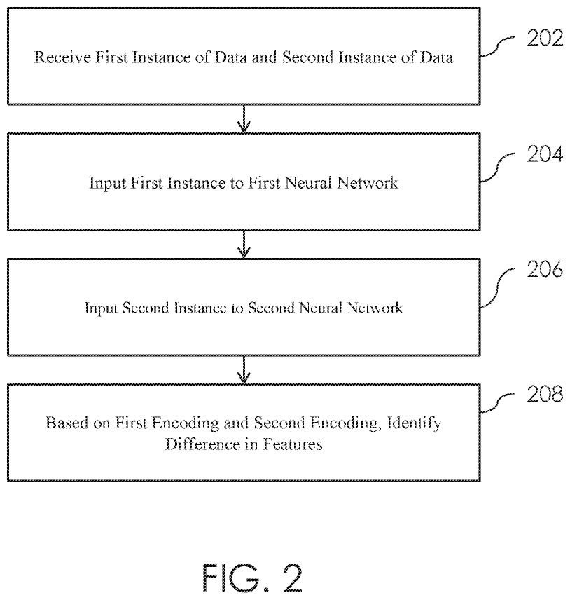

FIG. 2 is a flow diagram illustrating a method of identifying differences in comparative examples using neural network architecture formed with at least two neural network models in an embodiment. The method can be implemented or run on one or more computer processors, for example, including one or more hardware processors. In an embodiment, the neural network architecture is a Siamese neural network. At 202, a first instance of data and a second instance of data can be received. The first instance of data and the second instance of data, for example, have been classified differently, e.g., by a machine learning model. The machine learning model can include an artificial neural network or another model. By way of example, in an embodiment, the first instance of data and the second instance of data can be text data including one or more sentences. For instance, the first instance of data can include a news article, an email data, other text content. Similarly, the second instance of data can include a news article, an email data, other text content. A machine learning model may have classified those two instances of data into different classes, for example, different topics. As another example, in an embodiment, the first instance of data and the second instance of data can be images, e.g., of objects, scenes, and/or others.

In an embodiment, the two instances are input to the neural network architecture having at least two neural networks. For example, at 204, the first instance can be input to a first neural network, where the first neural network generates a first encoding associated with the first instance. For instance, the first encoding can be features of a logit layer of the first neural network. At 206, the second instance can be input to a second neural network, where the second neural network generates a second encoding associated with the second instance. The second encoding can be features of a logit layer of the second neural network. For example, the first neural network and the second neural network form neural network architecture trained to learn similarities in given pair of input objects. For example, such neural network architecture can be trained based on triplets such as anchor, positive and negative samples.

At 208, based on the first encoding and the second encoding, a difference can be identified in features of the first instance and the second instance, which contributed to the first instance and the second instance being classified differently.

In an embodiment, the first neural network and the second neural network have identical hyperparameters and weights, for example, the same configuration. In an embodiment, to identify a difference in features of the first instance and the second instance, a processor may compute gradients of distance differences between the first encoding features and the second encoding features with respect to the first instance of data. In an embodiment, a processor may select a top predefined number of features having largest negative values to identify the difference in features of the first instance and the second instance.

In an embodiment, a processor may compute the gradient of the loss between the first encoding and the second encoding with respect to the first instance of data (or the second instance of data), and further a post processing to the gradient to reduce noise. In an embodiment, such post processing may include computing a product of the gradient and the first instance of data (or the second instance of data).

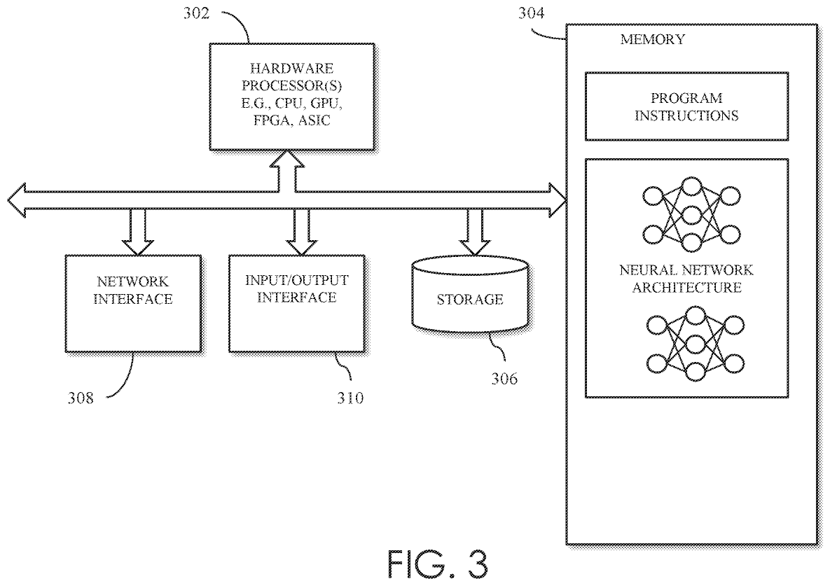

FIG. 3 is a diagram showing components of a system in one embodiment that can generate a comparative explanation toward why given input instances result in different prediction outcome in machine learning. One or more hardware processors 302 such as a central processing unit (CPU), a graphic process unit (GPU), and/or a Field Programmable Gate Array (FPGA), an application specific integrated circuit (ASIC), and/or another processor, may be coupled with a memory device 304. A memory device 304 may include random access memory (RAM), read-only memory (ROM) or another memory device, and may store data and/or processor instructions for implementing various functionalities associated with the methods and/or systems described herein. One or more processors 302 may execute computer instructions stored in memory 304 or received from another computer device or medium. A memory device 304 may, for example, store instructions and/or data for functioning of one or more hardware processors 302, and may include an operating system and other program of instructions and/or data. One or more hardware processors 302 may receive a first instance of data and a second instance of data, which have been classified differently. One or more hardware processors 302 may input the first instance to a first neural network, the first neural network generating a first encoding associated with the first instance. One or more hardware processors 302 may input the second instance to a second neural network the second neural network generating a second encoding associated with the second instance, where the first neural network and the second neural network form neural network architecture trained to learn similarities in given pair of input objects. One or more hardware processors 302 may, based on the first encoding and the second encoding, identify a difference in features of the first instance and the second instance, which contributed to the first instance and the second instance being classified differently. The input instances may be stored in a storage device 306 or received via a network interface 308 from a remote device, and may be temporarily loaded into a memory device 304 for providing a comparative explanation. The learned first and second neural networks may be stored on a memory device 304, for example, for running by one or more hardware processors 302. One or more hardware processors 302 may be coupled with interface devices such as a network interface 308 for communicating with remote systems, for example, via a network, and an input/output interface 310 for communicating with input and/or output devices such as a keyboard, mouse, display, and/or others.

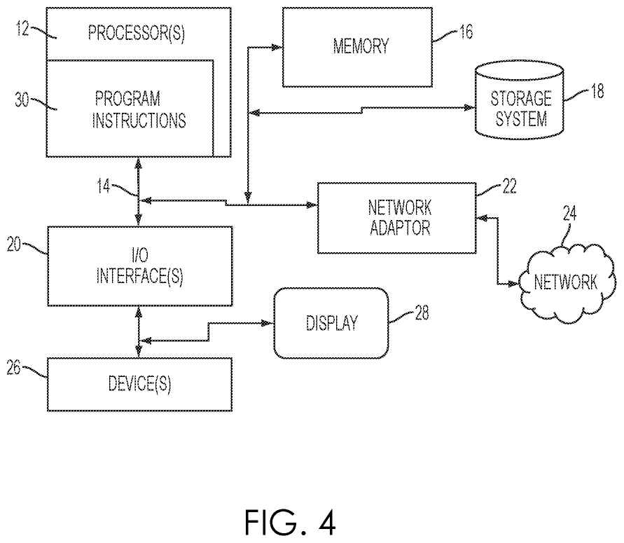

FIG. 4 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

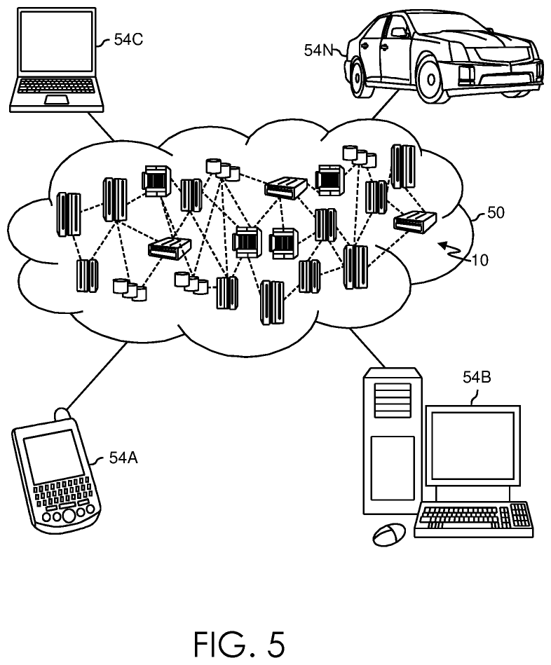

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

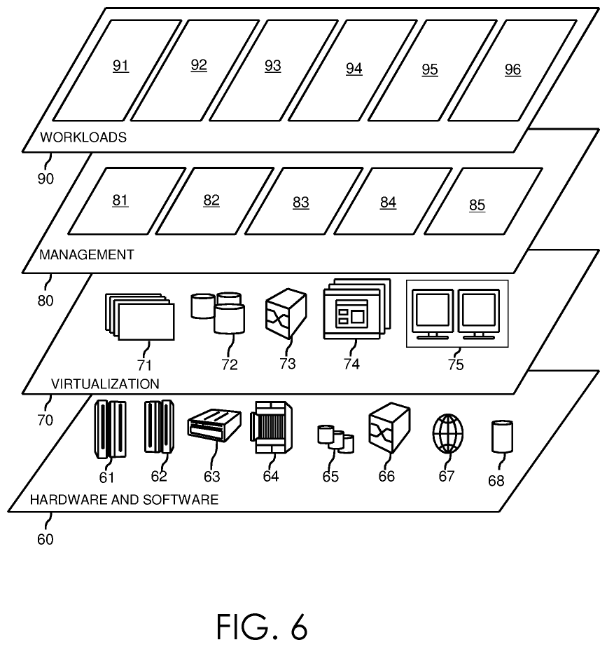

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing explanation of difference in prediction outcomes of at least two instances processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving a first instance of data and a second instance of data, which have been classified differently;
inputting the first instance to a first neural network, the first neural network generating a first encoding associated with the first instance;
inputting the second instance to a second neural network the second neural network generating a second encoding associated with the second instance,
wherein the first neural network and the second neural network form neural network architecture trained to learn similarities in given pair of input objects;
based on the first encoding and the second encoding, identifying a difference in features of the first instance and the second instance, which contributed to the first instance and the second instance being classified differently.

2. The method of claim 1, wherein the first neural network and the second neural network have identical hyperparameters and weights.

3. The method of claim 1, wherein the identifying a difference in features of the first instance and the second instance, includes:
computing gradients of distance differences between the first encoding features and the second encoding features with respect to the first instance of data.

4. The method of claim 3, further selecting a top feature having largest negative value to identify the difference in features of the first instance and the second instance.

5. The method of claim 1, wherein the identifying a difference in features of the first instance and the second instance, includes:
computing a gradient of a distance difference between the first encoding and the second encoding with respect to the first instance of data; and
performing a post processing to the gradient to reduce noise.

6. The method of claim 5, wherein the post processing includes multiplying the gradient with the first instance of data.

7. The method of claim 1, wherein the identifying a difference in features of the first instance and the second instance, includes providing an explanation including a ranked list of features from the first instance and the second instance, which contributed to the first instance and the second instance being classified differently.

8. A system comprising:
a processor;
a memory device coupled with the processor;
the processor configured to at least:
receive a first instance of data and a second instance of data, which have been classified differently;
input the first instance to a first neural network, the first neural network generating a first encoding associated with the first instance;
input the second instance to a second neural network the second neural network generating a second encoding associated with the second instance,
wherein the first neural network and the second neural network form neural network architecture trained to learn similarities in given pair of input objects;
based on the first encoding and the second encoding, identify a difference in features of the first instance and the second instance, which contributed to the first instance and the second instance being classified differently.

9. The system of claim 8, wherein the first neural network and the second neural network have identical hyperparameters and weights.

10. The system of claim 8, wherein the processor is configured to compute gradients of distances difference between the first encoding features and the second encoding features with respect to the first instance of data, to identify a difference in features of the first instance and the second instance.

11. The system of claim 10, wherein the processor is configured to select a top predefined number of features having largest negative values to identify the difference in features of the first instance and the second instance.

12. The system of claim 8, wherein the processor is configured to compute gradient of loss between the first encoding and the second encoding with respect to the first instance of data, the processor further being configured to perform a post processing to the gradient to reduce noise.

13. The system of claim 12, wherein the post processing includes computing a product of the gradient and the first instance of data.

14. The system of claim 8, wherein the processor is configured to provide an explanation including a ranked list of features from the first instance and the second instance, which contributed to the first instance and the second instance being classified differently.

15. A computer program product comprising a computer readable storage medium having program instructions embodied therewith, the program instructions readable by a device to cause the device to:
receive a first instance of data and a second instance of data, which have been classified differently;
input the first instance to a first neural network, the first neural network generating a first encoding associated with the first instance;
input the second instance to a second neural network the second neural network generating a second encoding associated with the second instance,
wherein the first neural network and the second neural network form neural network architecture trained to learn similarities in given pair of input objects;
based on the first encoding and the second encoding, identify a difference in features of the first instance and the second instance, which contributed to the first instance and the second instance being classified differently.

16. The computer program product of claim 15, wherein the first neural network and the second neural network have identical hyperparameters and weights.

17. The computer program product of claim 15, wherein the device is caused to compute gradients of distance differences between the first encoding features and the second encoding features with respect to the first instance of data, to identify a difference in features of the first instance and the second instance.

18. The computer program product of claim 17, wherein the device is caused to select a top predefined number of features having largest negative values to identify the difference in features of the first instance and the second instance.

19. The computer program product of claim 15, wherein the device is caused to compute a gradient of loss between the first encoding and the second encoding with respect to the first instance of data, the processor further being configured to perform a post processing to the gradient to reduce noise.

20. The computer program product of claim 19, wherein the post processing includes computing a product of the gradient and the first instance of data.
